(19) United States
(12) Patent Application Publication
(10) Pub. No.: US 2009/0124314 A1
(43) Pub. Date: May 14, 2009

(54) ELECTRONIC POKER GAME

(75) Inventors: Christopher John Cornelius Halligan, Weddington, NC (US); Vito Anthony Casucci, Las Vegas, NV (US)

Correspondence Address: Stephen B. Salai, Esq.;Harter Secrest & Emery LLP, 1600 Bausch & Lomb Place, Rochester, NY, 14604-2711, US

(73) Assignee: PokerTek, Inc., Matthews, NC (US)

(21) Appl. No.: 11/937,886

(22) Filed: Nov. 9, 2007

(51) Int. Cl. A63F 13/02

(52) U.S. Cl. 463/13

(57) ABSTRACT

A method for playing a series of electronic card games includes, prior to beginning the series of electronic card games, determining a jackpot event and a minimum jackpot for the series of electronic card games, and insuring against the jackpot event for the minimum jackpot. The method also includes determining a jackpot winner in response to the jackpot event and paying at least a portion of the minimum jackpot in response to the determined jackpot winner.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A “SEQUENCE LISTING”

Not applicable.

### BACKGROUND OF THE INVENTION

1. Field of the Invention

The present disclosure relates to a system and method for incorporating a jackpot into an electronic poker table and, in particular, to a system and method for insuring bad beat poker jackpots on an electronic poker table.

2. Description of Related Art

Gaming is an increasingly popular form of entertainment. Games, particularly games of chance and skill in which one or more players play and place wagers on the outcome thereof may be played in a variety of ways, including at a casino or other venue. Of the various forms of games which are available for play, many are played with playing cards. Of these, poker is one of the most popular.

Traditionally, poker is played at a table with several players wagering paper, coin money or chips on a series of playing cards dealt from a deck of fifty-two cards. This deck is comprised of four suits at thirteen cards per suit. This form of poker requires a human dealer to coordinate the game, including dealing, wagering, folding, etc.

At the same time, casinos and other venues often incorporate a jackpot into poker games played at traditional poker tables to increase the level of excitement and anticipation among the players. One common type of jackpot is a bad beat jackpot in which a losing player is awarded at least a portion of a jackpot or a fixed sum in response to losing when the player had a considerably good hand, e.g., a full house with Aces and Jacks. Mystery jackpots are also a popular jackpot feature incorporated into poker games.

However, traditional poker suffers from several problems, such as the possibility of human/dealer error and fraud or other forms of cheating by the players. Moreover, given the decision-making needed to determine when a player is a bad beat or mystery jackpot winner at a traditional poker table, these types of jackpots are also subject to dealer/human error, and are therefore usually limited to being administered manually at individual poker tables.

The disclosed system and method are directed towards overcoming one or more of the problems set forth above.

### SUMMARY OF THE INVENTION

In an exemplary embodiment of the present disclosure, a method for playing a series of electronic card games includes, prior to beginning the series of electronic card games, determining a jackpot event and a minimum jackpot for the series of electronic card games, and insuring against the jackpot event for the minimum jackpot. The method also includes determining a jackpot winner in response to the jackpot event and paying at least a portion of the minimum jackpot in response to the determined jackpot winner.

In another exemplary embodiment of the present disclosure, a method for playing a series of electronic card games includes, prior to beginning the series of electronic card games, determining a minimum jackpot for the series of games and a jackpot event. The method also includes obtaining an insurance policy corresponding to the minimum jackpot and the jackpot event. The method further includes paying the predetermined minimum jackpot in response to a determination of the jackpot event occurring within the series of games.

In a further exemplary embodiment of the present disclosure, a method for playing a series of electronic poker games includes, prior to beginning the series of electronic poker games, determining a minimum bad beat jackpot for the series of games and a bad beat qualifying hand, and obtaining an insurance policy corresponding to the predetermined minimum bad beat jackpot and the bad beat qualifying hand within the series of games. The method also includes paying the predetermined minimum bad beat jackpot in response to the bad beat qualifying hand within the series of games.

### BRIEF DESCRIPTION OF THE DRAWINGS

FIG. 1 is a diagrammatic illustration of a system for providing an electronic poker game on one or more electronic poker tables, according to an exemplary embodiment of the present disclosure.

FIG. 2 is a diagram of a table top of the electronic poker tables of FIG. 1, according to an embodiment of the present disclosure.

FIG. 3 is a diagram of a tabletop of the electronic poker tables of FIG. 1, according to another embodiment of the present disclosure.

FIG. 4 is a flowchart illustrating an exemplary method of the present disclosure.

### DETAILED DESCRIPTION OF THE DRAWINGS

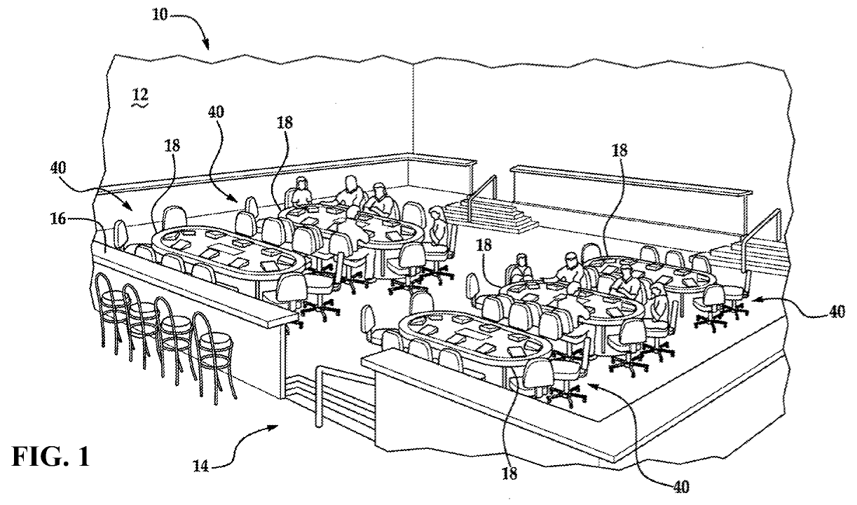

FIG. 1 illustrates a system 10 designed to be situated in a gaming environment, such as a casino 12. Typically, such gaming environments 12 are a specialized or designated area within the casino 12, such as a poker room or poker area 14, which has been cordoned off by, for example, a railing 16. While FIG. 1 illustrates one possible implementation or location in which the system 10 may be used, the exemplary systems and methods of the present disclosure are not limited to any such location or implementation.

In an exemplary embodiment, the system 10 utilizes electronic chips and electronic playing cards to provide an automated card game for play by two or more players. In one aspect of the present disclosure, a human dealer is not required and the system 10 may handle all dealer functions. The system 10 may be used to play any variation or version of any card game. However, for the purposes of discussion, the system 10 will be described as adapted for use in implementing the version of poker known as, Texas Hold'em.

In one aspect of the present disclosure, the system 10 may handle assigning players to a seat, providing electronic chips, accepting wagers, and assigning a pot to the winning player. The system 10 electronically shuffles a set of electronic playing cards and deals the electronic playing cards to the player. The system also deals any common cards to an electronic card or poker table 18. The system 10 may also handle wagering, folding, and calling by the players, and may restrict such actions based on whose turn it is.

The card or poker tables 18 of the system 10 can be networked and/or otherwise connected to one or more servers (not shown). In an exemplary embodiment, the poker tables 20 can be networked together using, e.g., an Ethernet network. One or more of the servers may be used to provide functionality for the system 10. For example, the server may be used to implement various functions, including, but not limited to: starting and stopping the tables 18 on a game, data and player tracking, cashless wagering, defining and modifying table parameters including turning the tables 18 on and off, setting the poker game being played at the table 18, and setting wager parameters. Such functions can also include defining and managing jackpots, including the house percentage, i.e., the rake, defining and managing progressive jackpots, establishing and managing an electronic waiting list for players, assigning players to seats and/or specific tables from the electronic waiting list, and establishing and managing tournament play, including assigning player seats, collapsing tables, etc.

The system 10 also includes a plurality of electronic poker tables 18. In the embodiment shown in FIG. 1, the system 10 includes five electronic poker tables 18, although the present disclosure is not limited to a specific number of electronic poker tables. The system 10 and poker tables 18 of FIG. 1, although electronic, are designed to convey and retain the overall sense and ambience of a standard poker room with non-electrical poker tables. Each electronic poker table 18 is surrounded by a number of poker chairs 40.

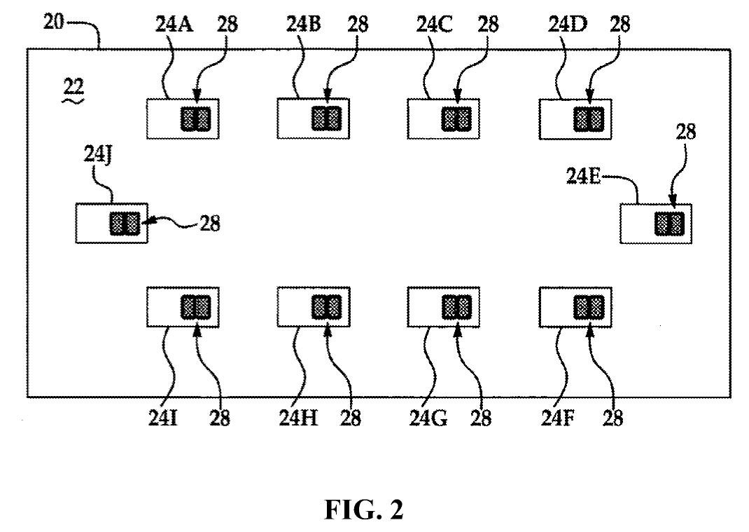

A representative layout of a table top 20 of the poker tables 18, according to an exemplary embodiment of the present disclosure is shown in FIG. 2. The table top 20 includes a playing surface 22 and a plurality of electronic player interaction areas (“EPIAs”) 24. In the embodiment illustrated in FIG. 2, the poker tables 18 are able to seat a maximum of ten players at a time, and thus, include ten EPIAs 24A-24J. The table top 10 also includes a central or common display area (CDA) 26. It is understood that the electronic and substantially automated nature of the EPIAs 24A-24J and the CDA 26 described herein assist in reducing both the human/dealer error and the player fraud and/or other forms of cheating associated with traditional card games such as poker. Depending on the game being played on the table top 20, in an exemplary embodiment of the present disclosure the CDA 26 can be omitted.

In one embodiment, the individual EPIAs 24 are used to convey game information directly to a player assigned to a specific player interaction area 24 and to implement a player user interface to effectuate interaction or input from the player. The CDA 26, on the other hand, is used to display information to all of the players.

In an exemplary embodiment, the system 10 can be used to play the version of poker known as Texas Hold'em. In Texas Hold'em, each player is dealt a number of cards, e.g., two cards, face down. These are known as a player's “hole” cards 28. A number of cards, e.g., three or five, are dealt face-up and displayed in the CDA 26. These are known as the common cards 30. A player's hand, thus, includes the player's hole cards 28 and the common cards 30. At the end of each hand, of the remaining players, whichever player's hand makes the highest poker hand is the winner of that round or hand of poker.

In one aspect of the present disclosure, the hole cards 28 are displayed face-down on the respective EPIA 24 and the common cards are displayed in the CDA 26. The hole cards 28 are displayed at a first predetermined ratio and the common cards 30 are displayed at a second predetermined ratio. The first and second predetermined ratios may be expressed as a ratio of a standard size playing card or a predetermined default size. For example, the first and second ratios may be defined such that the common cards 30 are displayed larger than the hole cards 28.

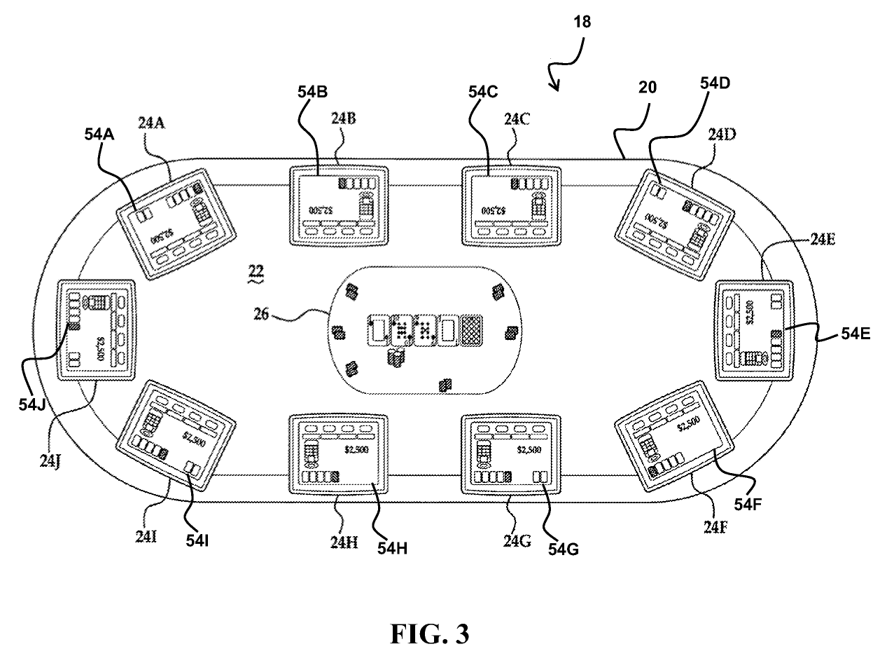

As shown in FIG. 3, the EPIAs 24A-24J can comprise separate display devices such as, for example, touch screen displays, and each display may be housed in a removable module. Each EPIA 24 may further comprise a fully-functional computer. The computer can include a processor capable of running an operating system, such as Windows XP or Windows CE, both available from Microsoft Corporation of Redmond, Wash. The EPIAs 24 can also comprise a card reader (not shown) for reading, for example, a player ID card.

In the exemplary embodiment of FIG. 3, the EPIAs 24A-24J are mounted into the table top 20, such that the touch screen and/or other display is substantially parallel to the table top 20. However, in an additional exemplary embodiment, the display may be mounted at an angle with respect to the table top 20. Alternatively, the EPIAs may be adjustable to provide an adjustable viewing angle of the touch screen display. It is understood that mounting the display at an angle and/or adjustably mounting the EPIAs 24A-24J can assist in reducing player fraud and/or cheating during the electronic card games being played at the tables 18. Moreover, the CDA 26 can be implemented in a separate display such as, for example, an LCD monitor, a plasma monitor, and/or any other similar device. The remainder of the table top 20 may be covered in a material such as, for example, green, blue, or red felt, and logos, game information, or other information may be printed on the material.

In still another exemplary embodiment, the EPIAs 24 and the CDA 26 may be implemented in a single display which covers a large portion of the table top 20. The EPIAs 24 and the CDA 26 may be set apart from the rest of the table top 20 by virtual borders (not shown). The areas of the display around the EPIAs 24 and the CDA 26 may be used to simulate the table top of a standard poker table, e.g., an image of material, such as green felt, may be displayed. Furthermore, logos, game information, other information, advertisements, announcements, pictures, videos, or other information may be displayed, rotated, cycled, or displayed for a limited period of time on the table top 20 and/or the EPIAs 24.

In an exemplary embodiment of the present disclosure, the system 10 can implement a player-account based cash in/cash out system. In such an embodiment, the system 10 can create a user account for each player. Once an account is established for the player, the player is issued a Player Card having an associated personal identification number or PIN. Once the player has been issued a Player Card, their account may be funded. The Player Card can be used to identify the player at the tables 18. The player may fund their account by bringing cash to a cage, where the cash is accepted and credited to the player's account. Printed receipts can be given to the player and maintained by the casino 12. To bring electronic chips to the table 18, the player sits down at a seat, swipes their Player Card and enters their PIN. The system 10 informs the player of their account balance and allows them to convert all or a portion of the account balance to electronic chips to bring to the game.

Each EPIA 24 can implement a player interface 54A-54J. The player interfaces 54 may be implemented on the table top 20 or in the EPIAs 24. In another embodiment, the player interface 54 may be implemented on a hand-held device (not shown), such as a personal data assistant (PDA). The player interface 54 may be graphical in nature (as shown in FIG. 3), or may take other forms, such as a simple textual format. In one embodiment the EPIAs 24 can provide the players with the option of choosing between several player interfaces 54, such as a graphical representational of an electronic poker table, or the text interface.

In such an exemplary embodiment, the player interface 54 can represent each player in the poker game by a user graphic or icon which may list their names as well as their chip totals. In addition, the pot of the current hand can be represented in the center of the poker table 18 by stack(s) of chips and/or a number representing the value of the current pot. Each player's contribution to the pot can also be represented by stack(s) of chips and/or a number adjacent their user graphic.

The player interface 54 may also includes a series of player option buttons and a series of game buttons. The player option buttons may include, for example, a sit in button, a leave table button, and an options button. Generally, only one of the sit in button and the leave table button would be active at any time. The options button can allow the player to access an option menu or screen (not shown) which allows the player to modify certain parameters of the player interface 54, such as, for example, to choose between different formats of the player interface 54. The series of game buttons allow the player to signal their game play decisions to the system 10 during the play of the game. The game buttons may include a fold button, a call button, and a raise button. In one embodiment, the EPIA 24 only activates those buttons which are appropriate, given the rules of the game being played, during the current turn. For example, if the maximum number of raises for a particular game has already been made, then the wager or raise button would be inactive. Additionally, all of the buttons will be inactive when it is not the player's turn. In one embodiment, the buttons are implemented on the touch screen display devices of the EPIAs 24. In an alternative embodiment, the buttons are embodied in electromechanical switches or buttons on the poker table 18.

The player interface 54 can also include a graphical representation of one or more of electronic playing cards. Each electronic playing card has a front side and a back side. The back side of each card has an identical pattern or image such that the cards cannot be told apart when viewing the back side. The electronic playing card is typically one of a set or deck of standard playing cards. The deck may be a standard deck of 52 cards, each card having a value. The value being two components: the first component being one of a two through ACE and the second component being one of four suits (hearts, diamonds, clubs, spades). The value of each card can be indicated on the front side of each playing card displayed on the player interface 54.

In one embodiment, the electronic playing card or cards displayed on the player interface 54 are a player's hole card(s) in an electronic poker game. However, the electronic playing cards may be used in any sort of electronic card game in which it is desirable to controllably display/hide the player's cards. Thus, while the present disclosure may be described below in the context of an electronic poker game (and more specifically, with respect to a player's hole cards in a Hold'em style poker game), the present disclosure is not limited to such a card game.

In one aspect of the present disclosure, each EPIA 24 is assigned to a player. Once the player is assigned is to a particular seat at a table 18, the associated EPIA 24 may set as inactive or locked and may indicate the assigned player's name. Once the EPIA 24 is locked, the assigned player must login to the EPIA 24. A player may log-in to the system 10 or table 18 through the EPIA 24 and, in an exemplary embodiment, the player may log-in to the system 10 using a player tracking card. The player can insert or swipe their player tracking card through a card reader associated with the EPIA 24. The EPIA 24 may also require entry of a PIN into an attached keypad or keypad implemented on the touch screen display device. Alternatively or in addition, the player may log-in using a biometric parameter, such as a fingerprint, sensed by a sensor and a RFID card or chip.

In one embodiment, the system 10 can require that each player has a player account. The player account may have an associated balance which contains a dollar amount based on an amount of money deposited by the player and/or any winnings that they have collected, either through poker or some other game. Once a player has been identified by the EPIA 24, the player may download a dollar amount and purchase chips to play. Alternatively, a ticket (with for example a barcode), magnetic card, RFID card, or some other media (jointly referred to as a TICKET) may be inserted in the EPIA 24, the table 18, or at a kiosk. The TICKET may have an associated value which is either printed and/or encoded thereon or which is associated with the TICKET in the system 10. Once the player logs-in, the EPIA 24 becomes active and the player interface 54 is displayed. Also, since the EPIA 24 is active, the player may enter or sit-in on the game being played at the table 12 or adjust/modify any available options by actuating the options button(s) described above.

As previously discussed, the system 10 of the present disclosure can be used to play any known electronic card game such as, for example, electronic poker, blackjack, and other games common in casinos. Such games often incorporate jackpots of different types into the gambling experience, and the system 10 is configured to incorporate such jackpots into the electronic card game played at the tables 18. The jackpots can be any type of jackpot including, for example, progressive jackpots, mystery jackpots, double-up jackpots, bad beat jackpots, and any combination or variation thereof. To facilitate this, a jackpot administrator or other known software or device (not shown) can be electronically coupled to a plurality of EPIAs 24 at multiple electronic poker tables 18. The jackpot administrator can be, for example, part of the server discussed above, a component of the EPIAs 24, or a separate computer configured to operate the jackpot.

The system 10 of the present disclosure can also be used to incorporate aspects of insurance into the different card games being played thereon. In an exemplary embodiment, the licensor of the system 10 can obtain an insurance policy from a third party insurance underwriter against a given jackpot event. The jackpot event can be, for example, a desired poker hand, the odds of which can be determined by the insurance underwriter. Such hands can include, for example, a royal flush beating four 6s (exactly). Such a hand, as well as any four of a kind between the numbers 6 and 9, is the most unlikely hand combination in poker. Thus, such hands can be predetermined losing hands and/or predetermined winning hands.

The insurance policy described above would act to buffer the Licensor's risk of loss when such major jackpots are won by gamblers. In addition, because the insurance policies are written on electric gaming devices, the odds of payment can be accurately determined by the insurance underwriters without risk of interference or error due to human/dealer interaction and without the risk of fraud or other forms of cheating by the players. Accordingly, because any error associated with utilizing the services of a dealer and the forms of fraud often implemented by players of card games have been excluded by the system 10 described herein, insuring such jackpots can be cost-effective for the underwriter.

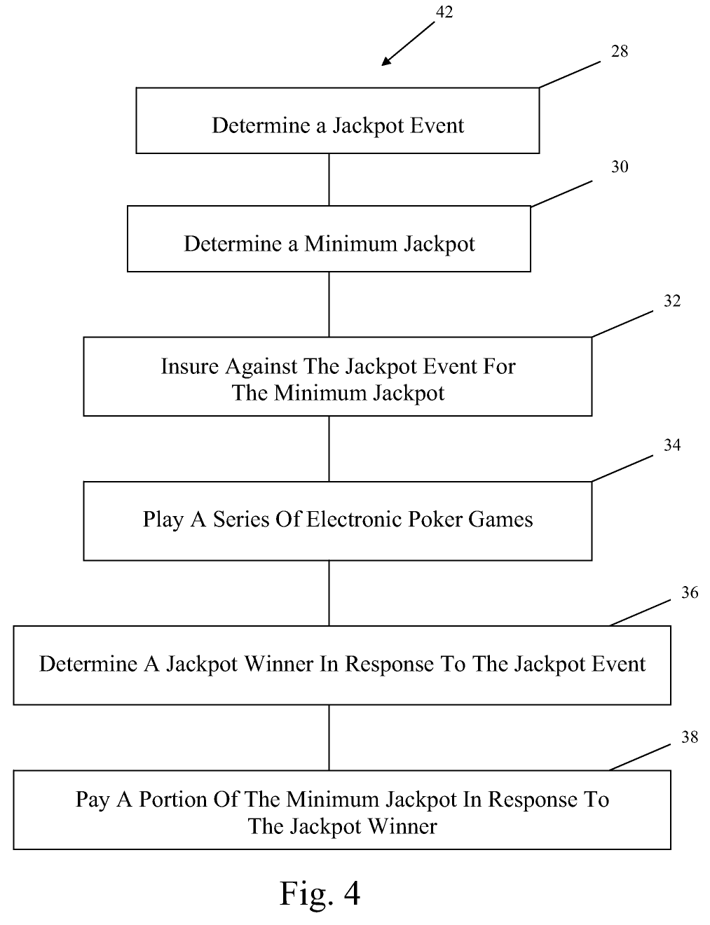

FIG. 4 shows a flowchart 42 illustrating a method for playing a series of electronic card games according to an exemplary embodiment of the present disclosure. Prior to beginning a series of electronic card games, a jackpot event can be determined by the casino (Step 28). As discussed above, the jackpot event can include a predetermined winning hand and a predetermined losing hand of any kind. In an exemplary embodiment, the jackpot event can be a bad beat qualifying hand. The casino can also determine and/or otherwise select a minimum jackpot for the series of electronic card games (Step 30). The minimum jackpot can be any desirable amount and can be at least partially funded from a series of electronic card games previously played. In an exemplary embodiment, the minimum jackpot can be independent of wagers within the current series of electronic card games, and the minimum jackpot can be any type of jackpot such as, for example, a bad beat jackpot. It is understood that the minimum jackpot can be cumulatively funded from the present series of card games and/or previous card game series. It is further understood that the minimum jackpot can grow to be greater than any cumulatively funded jackpot from the series of electronic card games.

As shown in FIG. 4, the method can also include obtaining an insurance policy from a third party insurer and/or otherwise insuring against the occurrence of the jackpot event for the minimum jackpot amount (Step 32). The insurance policy can be any type of policy known in the art. The insurance underwriter may be willing to insure against such an occurrence in an electronic card game environment based on the enhanced ability to predict the likelihood that a claim will be made against the policy (i.e., the likelihood of the selected jackpot event occurring). This enhanced ability is due to, for example, the lack of human interference with the games being played.

With the insurance policy in place, the system 10 of the present disclosure can be used to play a series of electronic games such as, for example, poker (Step 34). Aspects of the system 10 such as, for example, the jackpot administrator, can monitor the games for winners and losers. The system 10 can also keep track of the rake and the amount of money being used from each game to fund a bad beat jackpot or other jackpot. The system 10 can also determine a jackpot winner in response to the occurrence of the determined jackpot event (Step 36). Such a determination can be made automatically by the system 10. As discussed above, the card games being played on the system 10 can be electronic and, thus, the determination of the occurrence of a jackpot event can also be made electronically.

As shown in FIG. 4, the licensor of the system 10 can pay a portion of the minimum jackpot in response to the determined jackpot winner (Step 38). The portion of the minimum jackpot being paid can be at least partially funded by the insurance policy taken out by the licensor and, in an exemplary embodiment, the minimum jackpot can be fully funded by the insurance policy. In addition, at least the minimum jackpot can be paid in response to an electronically determined jackpot winner. The predetermined minimum jackpot can be paid in response to, for example, a preselected bad beat qualifying hand that is obtained by a gambler within the series of games being played on the system 10.

As discussed above, one of the advantages of the system and method of the present disclosure is the ability to electronically detect the first predetermined jackpot event. In poker games played at a traditional poker table in which a human dealer is used, the human dealer is required to visually detect such jackpot events and is, thus, subject to error. Another advantage of the system and method of the present disclosure is that, due to the use of electronic gaming tables, cheating and/or other fraudulent activities by the player can be eliminated. Due to these and other advantages described herein, a licensor of the disclosed system 10 may be able to obtain insurance policies protecting against, for example, the jackpot event.

Other embodiments of the disclosed apparatus 15 will be apparent to those skilled in the art from consideration of this specification. It is intended that the specification and examples be considered as exemplary only, with the true scope of the invention being indicated by the following claims.

What is claimed is:

1. A method for playing a series of electronic card games, the method comprising:
(a) prior to beginning the series of electronic card games (i) determining a jackpot event and a minimum jackpot for the series of electronic card games and (ii) insuring against the jackpot event for the minimum jackpot;
(b) determining a jackpot winner in response to the jackpot event; and
(c) paying at least a portion of the minimum jackpot in response to the determined jackpot winner.

2. The method of claim 1, wherein insuring against the jackpot includes obtaining an insurance policy from a third party insurer.

3. The method of claim 2, wherein paying at least a portion of the minimum jackpot is at least partially funded by the insurance policy.

4. The method of claim 2, wherein the minimum jackpot is fully funded by insurance policy.

5. The method of claim 1, wherein the minimum jackpot is greater than a cumulatively funded jackpot from the series of electronic card games.

6. The method of claim 1, wherein the jackpot event includes a predetermined losing hand and a predetermined winning hand.

7. The method of claim 1, wherein determining a jackpot winner is automatic.

8. The method of claim 1, wherein an amount of the minimum jackpot is independent of wagers within the series of electronic card games.

9. The method of claim 1, further comprising paying at least the minimum jackpot in response to an electronically determined jackpot winner.

10. A method for playing a series of electronic card games, the method comprising:
(a) prior to beginning the series of electronic card games, determining a minimum jackpot for the series of games and a jackpot event;
(b) obtaining an insurance policy corresponding to the minimum jackpot and the jackpot event; and
(c) paying the predetermined minimum jackpot in response to a determination of the jackpot event occurring within the series of games.

11. The method of claim 10, further comprising obtaining the insurance policy from a third party provider.

12. The method of claim 10, wherein paying the predetermined minimum jackpot is at least partially funded by the insurance policy.

13. The method of claim 10, wherein paying the predetermined minimum jackpot is in response to a bad beat qualifying hand within the series of games.

14. The method of claim 10, wherein the determination of the jackpot event occurring is electronic.

15. The method of claim 10, wherein the jackpot event is defined by a predetermined losing hand and a predetermined winning hand.

16. A method for playing a series of electronic poker games, the method comprising:
(a) prior to beginning the series of electronic poker games (i) determining a minimum bad beat jackpot for the series of games and a bad beat qualifying hand and (ii) obtaining an insurance policy corresponding to the predetermined minimum bad beat jackpot and the bad beat qualifying hand within the series of games; and
(b) paying the predetermined minimum bad beat jackpot in response to the bad beat qualifying hand within the series of games.

17. The method of claim 16, further comprising obtaining the insurance policy from a third party provider.

18. The method of claim 16, wherein paying the predetermined minimum bad beat jackpot is at least partially funded by the insurance policy.

19. The method of claim 16, further comprising electronically determining the bad beat qualifying hand within the series of games.

20. The method of claim 16, further comprising automatically electronically determining the bad beat qualifying hand within the series of games.

21. The method of claim 16, further comprising paying the predetermined minimum bad beat jackpot in conjunction with a predetermined winning hand.
